(19) United States
(12) Patent Application Publication
(10) Pub. No.: US 2026/0155683 A1
(43) Pub. Date: Jun. 4, 2026

(54) WIRELESS POWER TRANSFER DEVICE

(71) Applicant: Panasonic Automotive Systems Co., Ltd., Kanagawa (JP)

(72) Inventor: Motohiro SHIMIZU, Kanagawa Ken (JP)

(73) Assignee: Panasonic Automotive Systems Co., Ltd., Kanagawa (JP)

(21) Appl. No.: 19/383,208

(22) Filed: Nov. 7, 2025

(30) Foreign Application Priority Data
Nov. 29, 2024 (JP) 2024-208757

(51) Int. Cl. H02J 50/90; H02J 50/10; H02J 50/40

(52) U.S. Cl. CPC H02J 50/90; H02J 50/10; H02J 50/402

(57) ABSTRACT

A wireless power transfer device includes power transmitting coils, first search coils, second search coils, and a position detection device. The position detection device outputs a pulse signal to the first search coils and the second search coils and receives an echo signal from a power-transferred device via the first search coils and the second search coils. The position detection device detects a position of a power receiving coil of the power-transferred device placed on a charging surface based on detection voltages of the echo signal in the first and second search coils. The position detection device sets, as deactivated coils, first and second search coils that are positioned within a range of a predetermined distance from the position of the power receiving coil when power is being transferred via any of the power transmitting coils to the power receiving coil.

### CROSS-REFERENCE TO RELATED APPLICATIONS

This application is based upon and claims the benefit of priority from Japanese Patent Application No. 2024-208757, filed on November 29, 2024, the entire contents of which are incorporated herein by reference.

### FIELD

The present disclosure relates generally to a wireless power transfer device.

### BACKGROUND

Wireless charging (or power transfer) device have been known, which perform wireless charging of terminals such as mobile phones (See, for example, Patent literature JP 2009-189087 A). Recently, as Qi-compatible devices charged by a wireless charging device compliant to a Qi standard as a unified standard for wireless charging, products other than smartphones such as earphones, mice, and tablets have also been widely used, and one person generally owns a plurality of Qi-compatible devices.

Therefore, for charging such Qi-compatible devices in an environment such as an outdoor location, the inside of a vehicle interior, a train, a restaurant, etc., a charging stand having a larger charging area and capable of charging a plurality of Qi-compatible devices at once is desired rather than a dedicated charging stand for smartphones in the related art.

Incidentally, in the above-described charging stand capable of charging a plurality of terminals at once, a terminal search coil is provided to detect a terminal being placed on and detect a placement position of the terminal.

However, when the charging is already started for a terminal on a wireless charging stand, there is a concern that a position of a terminal newly placed on the stand cannot be accurately detected due to influence of a magnetic field generated by the charging of the former terminal.

### SUMMARY

A wireless power transfer device according to one aspect of the present disclosure includes a plurality of power transmitting coils, a plurality of first search coils, a plurality of second search coils, a position detection device, a moving system, and a plurality of power transmission circuits. The first search coils are arranged in rows in a first direction. The second search coils are arranged in rows in a second direction intersecting the first direction. The position detection device is configured to output a position detection pulse signal to the first search coils and the second search coils, receive an echo signal from a power-transferred device via the first search coils and the second search coils, and detect a position of a power receiving coil of the power-transferred device placed on a predetermined charging surface based on detection voltages of the echo signal in the first search coils and the second search coils. The moving system is configured to move one of the power transmitting coils to a position facing the position of the power receiving coil detected by the position detection device. The power transmission circuits are configured to supply power for transfer to the power transmitting coils. The position detection device is configured to set, as deactivated coils, the first search coil and the second search coil that are positioned within a range of a predetermined distance from the position of the power receiving coil of the power-transferred device when power is being transferred via any of the power transmitting coils to the power receiving coil.

### BRIEF DESCRIPTION OF THE DRAWINGS

FIG. 1 is a plan view illustrating main parts of a wireless power transfer device according to a first embodiment;

FIG. 2 is a front view illustrating the main parts of the wireless power transfer device according to the first embodiment;

FIG. 3 is a side view illustrating the main parts of the wireless power transfer device according to the first embodiment;

FIG. 4 is an exploded perspective view illustrating the wireless power transfer device according to the first embodiment;

FIG. 5 is a perspective view illustrating the wireless power transfer device according to the first embodiment;

FIG. 6 is a block diagram illustrating the wireless power transfer device and a power receiving terminal according to the first embodiment;

FIGS. 7A, 7B and 7C, are diagrams illustrating a detection voltage waveform in a first search coil and a second search coil;

FIG. 8 is a process flowchart illustrating an operation of the first embodiment;

FIG. 9 is a diagram illustrating a setting of a first search coil that is not used for position detection and is deactivated;

FIG. 10 is a process flowchart illustrating an operation of a second embodiment;

FIG. 11 is a process flowchart (1) illustrating an operation of a third embodiment;

FIG. 12 is a process flowchart (2) illustrating the operation of the third embodiment;

FIG. 13 is a diagram illustrating a threshold voltage setting example;

FIG. 14 is a diagram illustrating an X-coordinate range; and

FIG. 15 is a diagram illustrating a specific example of a fourth embodiment.

### DETAILED DESCRIPTION

In each of the following embodiments, a method of controlling a wireless power transfer device 1 according to the present disclosure will be described with the relevant drawings. Note that each of the following embodiments is merely one of various embodiments of the present disclosure. For each of the following embodiments, as long as the object of the present disclosure can be achieved, various changes can be made on designs and the like. The following embodiments may be implemented by appropriately combining the embodiments including modification examples.

Each drawing illustrating each of the following embodiments is a schematic diagram, and ratios in size and thickness between components in the drawings do not necessarily reflect actual dimensional ratios.

Arrows indicating left, right, upper, and lower sides in each of the drawings are merely illustrated for convenience of description, and do not involve entities. Arrows indicating an X-axis and a Y-axis in each of the drawings are merely illustrated for convenience of description, and do not involve entities.

Left, right, upper, and lower directions in the present disclosure are merely exemplary, and are not intended to limit directions when using the wireless power transfer device 1.

An X-axis direction and a Y-axis direction intersect each other. In the description of the present disclosure, the X-axis direction and the Y-axis direction are orthogonal to each other, the X-axis direction matches with a left-right direction, and the Y-axis direction matches with a front-rear direction, but the X-axis direction and the Y-axis direction are not necessarily orthogonal to each other.

Flowcharts in the following description are merely examples of a method of using (method of controlling) the wireless power transfer device 1 according to the present disclosure, and the order of the process may be appropriately changed or the process may be appropriately added or skipped.

### First Embodiment

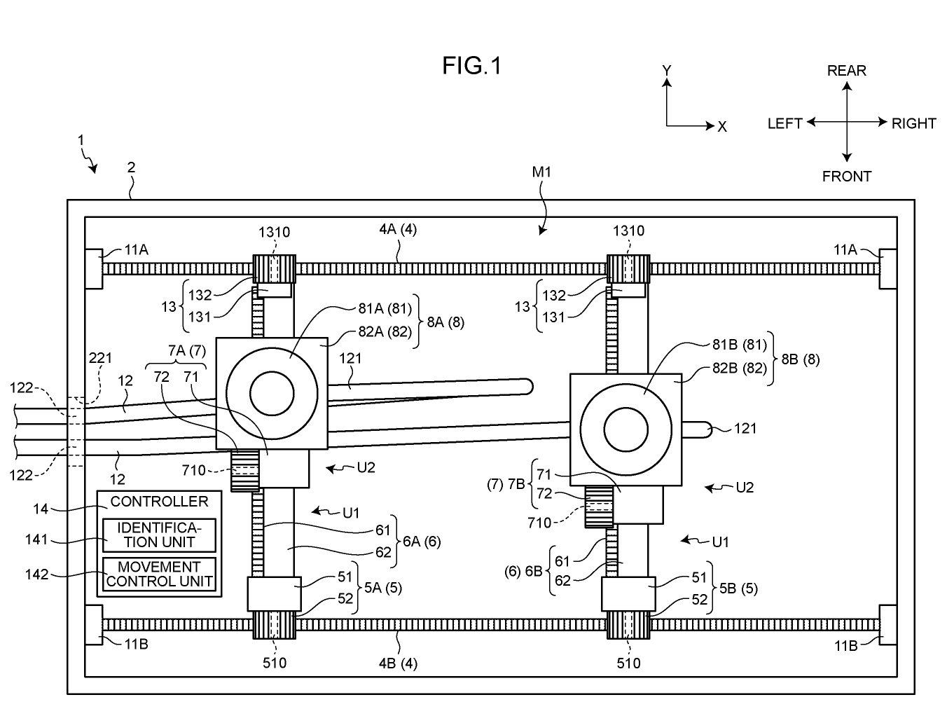

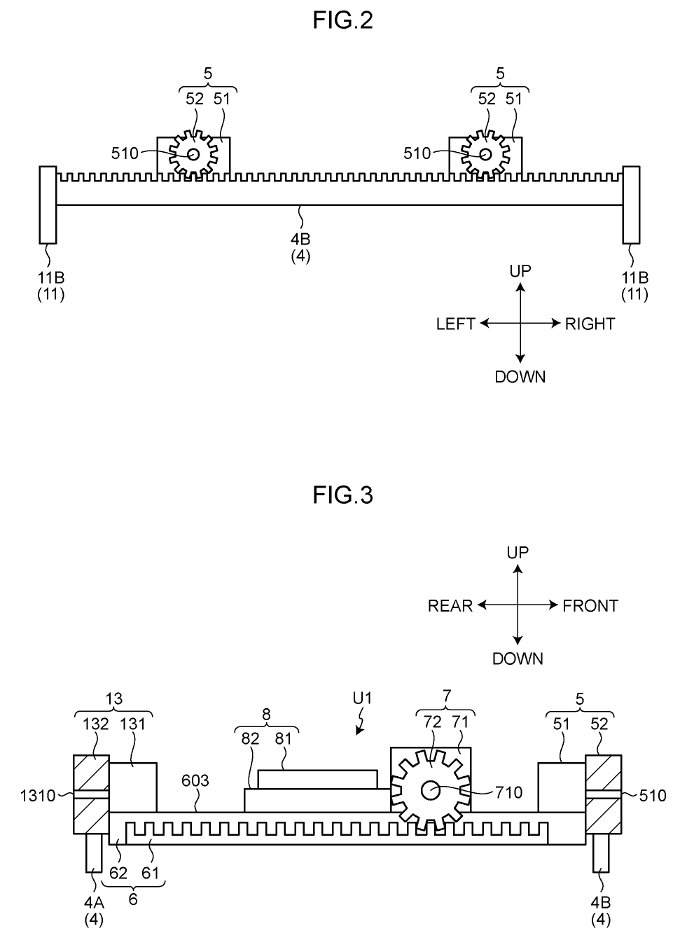

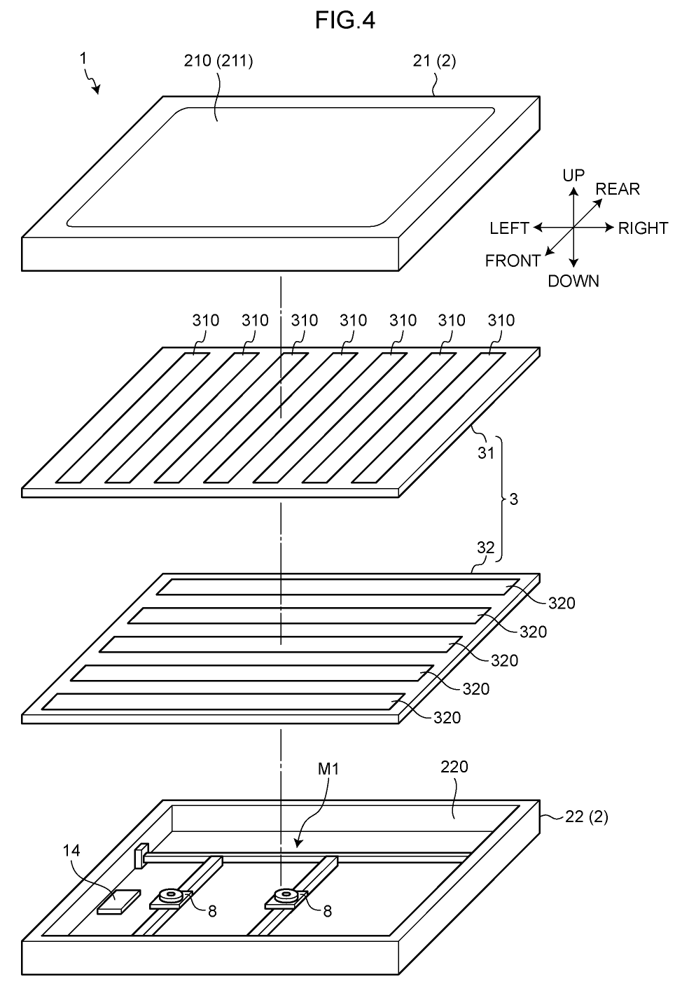

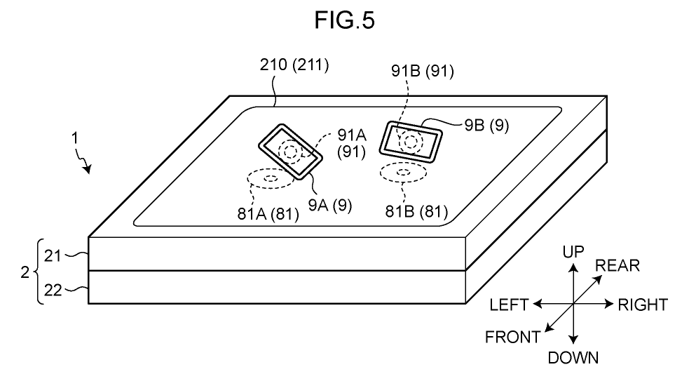

FIG. 1 is a plan view illustrating main parts of a wireless power transfer device 1 according to a first embodiment. FIG. 2 is a front view illustrating the main parts of the wireless power transfer device 1 according to the first embodiment. FIG. 3 is a side view illustrating the main parts of the wireless power transfer device 1 according to the first embodiment. FIG. 4 is an exploded perspective view illustrating the wireless power transfer device 1 according to the first embodiment. FIG. 5 is a perspective view illustrating the wireless power transfer device 1 according to the first embodiment. When a power receiving terminal 9 (refer to FIG. 5) is placed in a power-transmittable area 210 (refer to FIG. 5) on a surface of the wireless power transfer device 1, the wireless power transfer device 1 transmits power to the power receiving terminal 9. The power receiving terminal 9 operates by the power received from the wireless power transfer device 1, or charges a battery by the power received from the wireless power transfer device 1.

As illustrated in FIG. 1, the wireless power transfer device 1 according to the present embodiment includes a power transmitting unit 8, a position detection device 3 (refer to FIG. 4), a moving system M1, and a housing 2. The power transmitting unit 8 includes a power transmitting coil 81. The power transmitting coil 81 transmits power to a power receiving coil 91 provided in the power receiving terminal 9. The position detection device 3 detects a position of the power receiving coil 91. The moving system M1 moves the power transmitting coil 81 to a position facing the power receiving coil 91 based on the position of the power receiving coil 91 detected by the position detection device 3. In the above-described configuration, the housing 2 accommodates the power transmitting unit 8, the moving system M1, and the position detection device 3. The moving system M1 includes an X-axis rail 4 provided in the X-axis direction, a Y-axis rail 6 provided in the Y-axis direction intersecting the X-axis direction, an X-axis driving unit 5 that moves the Y-axis rail 6 along the X-axis rail 4, and a Y-axis driving unit 7 that moves the power transmitting unit 8 along the Y-axis rail 6, the power transmitting unit 8 being movably connected to the Y-axis rail 6. The Y-axis rail 6 is movably connected to the X-axis rail 4. The X-axis driving unit 5 is held by the Y-axis rail 6. The Y-axis driving unit 7 is held by the power transmitting unit 8.

As illustrated in FIG. 1, the wireless power transfer device 1 according to the present embodiment includes two power transmitting units 8, two Y-axis rails 6, two X-axis driving units 5, and two Y-axis driving units 7.

Hereinafter, the two power transmitting units 8 will also be referred to as a first power transmitting unit 8A and a second power transmitting unit 8B, respectively. The power transmitting coil 81 provided in the first power transmitting unit 8A will also be referred to as a first power transmitting coil 81A, and the power transmitting coil 81 provided in the second power transmitting unit 8B will also be referred to as a second power transmitting coil 81B.

The two Y-axis rails 6 will also be referred to as a first Y-axis rail 6A and a second Y-axis rail 6B, respectively. The two X-axis driving units 5 will also be referred to as a first X-axis driving unit 5A and a second X-axis driving unit 5B, respectively. The two Y-axis driving units 7 will also be referred to as a first Y-axis driving unit 7A and a second Y-axis driving unit 7B, respectively.

The second power transmitting coil 81B of the second power transmitting unit 8B transmits power to the power receiving coil 91 in the power receiving terminal 9.

The second Y-axis rail 6B is movably connected to the X-axis rail 4. The second Y-axis rail 6B extends in the Y-axis direction.

The second X-axis driving unit 5B moves the second Y-axis rail 6B along the X-axis rail 4 independently of movement of the first Y-axis rail 6A. The second X-axis driving unit 5B is held by the second Y-axis rail 6B.

The second Y-axis driving unit 7B moves the second power transmitting unit 8B along the second Y-axis rail 6B, the second power transmitting unit 8B being movably connected to the second Y-axis rail 6B. The second Y-axis driving unit 7B is held by the second power transmitting unit 8B.

As such, the first Y-axis rail 6A and the second Y-axis rail 6B are movably connected to a common X-axis rail 4 such that the number of the X-axis rails 4 can be reduced and the moving system M1 can be downsized.

The moving system M1 of the wireless power transfer device 1 is controlled by a control method executed by a computer system. The moving system M1 moves each of the first power transmitting unit 8A including the first power transmitting coil 81A and the second power transmitting unit 8B including the second power transmitting coil 81B. The first power transmitting coil 81A transmits power to the power receiving coil 91 provided in the power receiving terminal 9. The second power transmitting coil 81B transmits power to the power receiving coil 91. The control method includes a position detection process and a movement control process. In the position detection process, the position of the power receiving coil 91 is detected. In the movement control process, the moving system M1 is controlled such that at least one of the first power transmitting coil 81A and the second power transmitting coil 81B are moved based on the position of the power receiving coil 91 detected in the position detection process.

When the position of one power receiving coil 91 is detected in the position detection process, one of the first power transmitting coil 81A and the second power transmitting coil 81B is moved to the position facing the one power receiving coil 91 in the movement control process. The first power transmitting unit 8A is movably connected to the first Y-axis rail 6A in the Y-axis direction. The second power transmitting unit 8B is movably connected to the second Y-axis rail 6B in the Y-axis direction. The first Y-axis rail 6A and the second Y-axis rail 6B are movably connected to the X-axis rail 4 in the X-axis direction intersecting the Y-axis direction. The movement control process includes a first process of moving the first Y-axis rail 6A along the X-axis rail 4, a second process of moving the first power transmitting unit 8A along the first Y-axis rail 6A, a third process of moving the second Y-axis rail 6B along the X-axis rail 4 independently of movement of the first Y-axis rail 6A, and a fourth process of moving the second power transmitting unit 8B along the second Y-axis rail 6B.

According to the above-described configuration, while the first Y-axis rail 6A and the second Y-axis rail 6B are movably connected to the common X-axis rail 4, the first power transmitting unit 8A and the second power transmitting unit 8B can be moved in the X-axis direction and the Y-axis direction by performing the first to fourth processes. Accordingly, convenience can be improved as compared to a case of moving only the first power transmitting unit 8A.

The first Y-axis rail 6A is movably connected to a first X-axis rail and the second Y-axis rail 6B is not movably connected to a first X-axis rail such that, compared to a case that the second Y-axis rail 6B is movably connected to a second X-axis rail, the number of the X-axis rails 4 can be reduced and the moving system M1 can be downsized.

Hereinafter, the wireless power transfer device 1 according to the present embodiment will be described in more detail. As illustrated in FIGS. 1 and 4, the wireless power transfer device 1 includes the first power transmitting unit 8A, the second power transmitting unit 8B, the position detection device 3, the moving system M1, the housing 2, and a controller 14.

The moving system M1 includes two X-axis rails 4 (4A and 4B), two X-axis driving units 5, two Y-axis rails 6, two Y-axis driving units 7, two cables 12, and two driven units 13. As illustrated in FIG. 1, it is preferable that the moving system M1 further includes two first support stands 11A and two second support stands 11B. By including the support stands, the moving system M1 can adjust heights of the X-axis rails 4.

As a result, in a plurality of wireless power transfer devices whose ranges of the power-transmittable areas 210 are different, or in a plurality of wireless power transfer devices whose shapes of the housings 2 are different, the moving system M1 can be shared and the cost can be reduced.

The wireless power transfer device 1 includes two Y-axis rail units U1 as illustrated in FIG. 1. Each of the two Y-axis rail units U1 is movably connected to the two X-axis rails 4. Each of the two Y-axis rail units U1 includes the power transmitting unit 8, the X-axis driving unit 5, the Y-axis rail 6, the Y-axis driving unit 7, the cable 12, and the driven unit 13 described above.

The number of the Y-axis rail units U1 is two in FIG. 1, and may be one or three or more. Each of the Y-axis rail units U1 provided in one wireless power transfer device 1 may have the same structure. Accordingly, there is an effect in that a manufacturing cost of those Y-axis rail units U1 can be reduced.

There is also an effect in that the Y-axis rail units U1 can be used in common for the wireless power transfer device 1 whose X-axis rail 4 is designed to be relatively long and the wireless power transfer device 1 whose the X-axis rail 4 is designed to be relatively short.

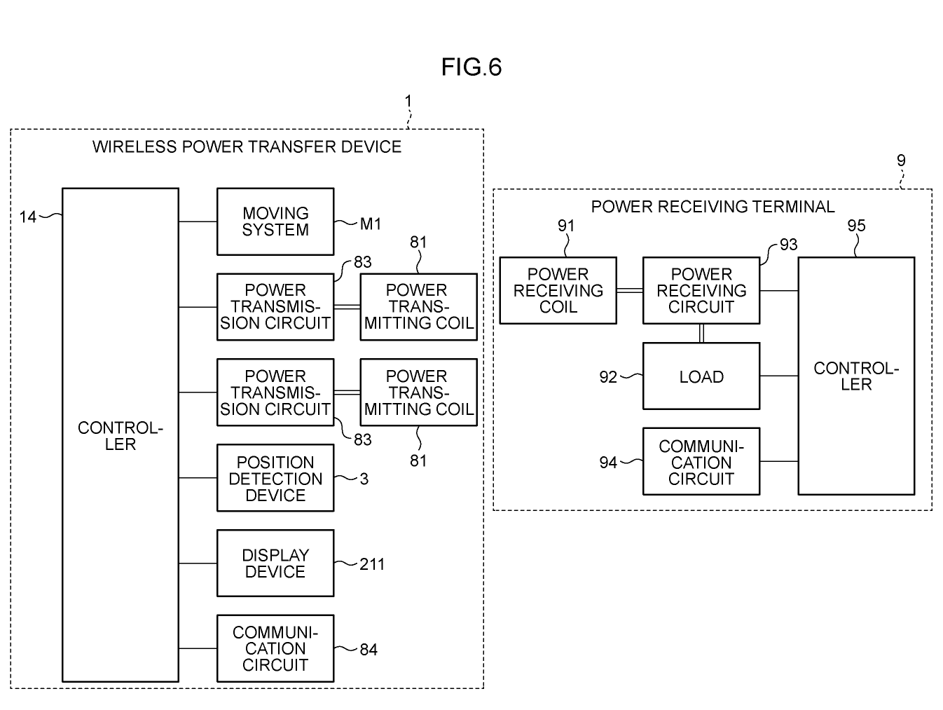

FIG. 6 is a block diagram illustrating the wireless power transfer device and the power receiving terminal 1 according to the first embodiment. As illustrated in FIG. 6, the wireless power transfer device 1 further includes a plurality of power transmission circuits 83 (two in FIG. 6) and a communication circuit 84. In FIG. 6, double lines connecting between units represent power lines, and single lines connecting between units represent communication lines.

The housing 2 includes a cover 21 and a base 22 as illustrated in FIGS. 4 and 5. The cover 21 has a cuboid shape. An opening is provided on a lower surface of the cover 21. The cover 21 includes a display device 211. As described below, the display device 211 executes a predetermined display. The display device 211 includes a monitor. A region where the display device 211 is provided includes at least part of the power-transmittable area 210. When the power receiving terminal 9 is placed in the power-transmittable area 210, one of the two power transmitting coils 81 moves to a position facing the power receiving coil 91 of the power receiving terminal 9 and transmits power to the power receiving coil 91.

The base 22 has a cuboid shape. An opening 220 is provided on an upper surface of the base 22. The opening 220 of the base 22 faces the opening on the lower surface of the cover 21. The cover 21 is attached to the base 22 and covers the opening 220 of the base 22. In a space between the cover 21 and the base 22, the two power transmitting units 8, the position detection device 3, and the moving system M1 are accommodated. More specifically, as illustrated in FIG. 4, the two power transmitting units 8 and the moving system M1 are disposed below the position detection device 3.

The controller 14 includes a computer system including one or more processors and memories. A computer program stored in the memory is executed by the processors of the computer system to implement at least some of functions of the controller 14. The program may be stored in the memory, may be provided via a telecommunication line such as the Internet, or may be provided by being stored in a non-transitory recording medium (for example, a memory card) readable by the computer system.

As illustrated in FIG. 1, the controller 14 includes an identification unit 141 and a movement control unit 142. The units merely represent functions implemented by the controller 14, and are not necessarily configurations having entities.

The identification unit 141 acquires the position of the power receiving coil 91 based on a detection result of the position detection device 3. The movement control unit 142 controls movements of the two power transmitting units 8 by controlling operations of the two X-axis driving units 5 and the two Y-axis driving units 7.

The controller 14 may be accommodated in the housing 2 as illustrated in FIG. 1. Alternatively, the controller 14 may be disposed outside the housing 2. The controller 14 may be a component of another device different from the wireless power transfer device 1.

The two power transmission circuits 83 correspond to the two power transmitting coils 81 one-to-one. Each of the power transmission circuits 83 supplies power to the corresponding power transmitting coil 81.

Each of the power transmission circuits 83 includes, for example, a full bridge inverter or an oscillation circuit such as a class D oscillation circuit or a class E oscillation circuit. The power transmission circuit 83 is connected to, for example, a DC power source, and converts DC power input from the DC power source into AC power and outputs the AC power. The AC power is supplied to the power transmitting coil 81 via the cable 12, and is transmitted to the power receiving terminal 9 by a medium that is a magnetic flux generated by the power transmitting coil 81 based on the principle of electromagnetic induction.

The communication circuit 84 wirelessly communicates with a communication circuit 94 of the power receiving terminal 9, and receives, for example, information on the power receiving terminal 9 necessary for power transmission from the power transmitting coil 81 to the power receiving coil 91. The information is transmitted to the controller 14 and used for control of transmission frequency of transmission power transmitted from the power transmitting coil 81, control of a magnitude of the transmission power, or the like.

The controller 14, the two power transmission circuits 83, and the communication circuit 84 may be consolidated into one package, or may be distributed and provided in two or more packages.

As illustrated in FIG. 4, the position detection device 3 includes a first detection unit 31 and a second detection unit 32. The first detection unit 31 includes a plurality of first search coils 310. The second detection unit 32 includes a plurality of second search coils 320. Each of the first search coils 310 extends in a front-rear direction as a first direction in the example of FIG. 4. The first search coils 310 are arranged in parallel to each other. Similarly, each of the second search coils 320 extends in a left-right direction as a second direction in the example of FIG. 4, and the second search coils 320 are arranged in parallel to each other.

Each of the first detection unit 31 and the second detection unit 32 has a plate shape. The first detection unit 31 overlaps the second detection unit 32 in an up-down direction.

The position detection device 3 includes, for example, a printed board, and the printed board is, for example, a double-sided board or a multi-layer board. The printed board includes a first layer (for example, a layer provided on an upper surface) and a second layer that overlaps the first layer in the up-down direction (for example, a layer provided on a lower surface or a layer provided between the upper surface and the lower surface). The first search coils 310 are arranged on the first layer of the printed board, and the second search coils 320 are arranged on the second layer of the printed board.

As illustrated in FIG. 4, each of the first search coils 310 has a rectangular shape in a plan view. A longitudinal direction of each of the first search coils 310 extends in the front-rear direction as the first direction. The first search coils 310 are arranged in parallel to each other in the left-right direction.

Each of the second search coils 320 has a rectangular shape in a plan view. A longitudinal direction of each of the second search coils 320 is provided in the left-right direction as the second direction. The second search coils 320 are arranged in parallel to each other in the front-rear direction.

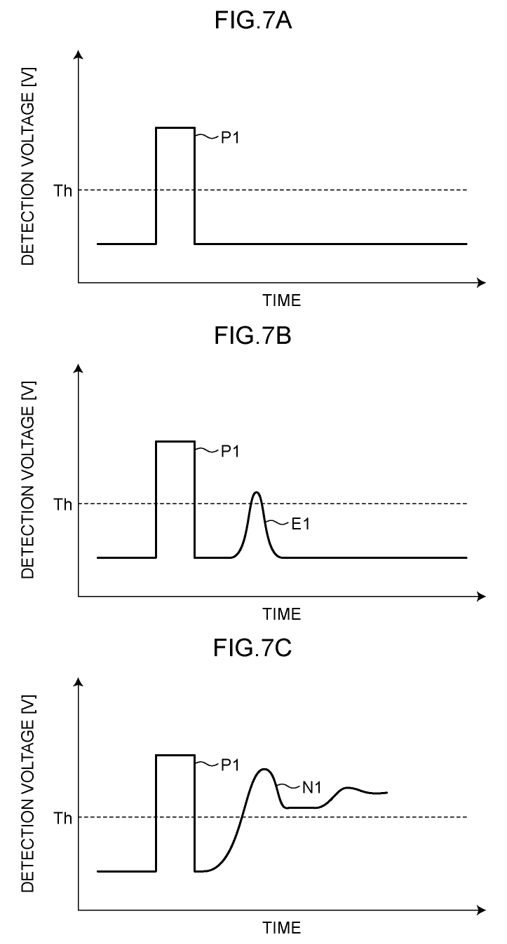

Next, a schematic operation of the position detection device 3 will be described. FIGS. 7A, 7B and FIG. 7C are diagrams illustrating a detection voltage waveform in the first search coil and the second search coil. It is assumed here that only one power receiving terminal 9 is placed in the power-transmittable area 210 and is not being charged. At a predetermined timing of position detection, the identification unit 141 of the controller 14 supplies a position detection pulse signal P1 (for example, a rectangular pulse with 1 MHz) as illustrated in FIG. 7A to the first search coils 310 and the second search coils 320.

When the power receiving terminal 9 is placed in a terminal placement region on the upper surface of the cover 21, the power receiving coil 91 of the power receiving terminal 9 is excited by the position detection pulse signal P1 and transmits an echo signal E1 as illustrated in FIG. 7B.

Then, one or more of the first search coils 310 near the power receiving coil 91 receive the echo signal E1 from the power receiving coil 91 and output the echo signal E1 to the identification unit 141. Similarly, one or more of the second search coils 320 near the power receiving coil 91 receive the echo signal E1 from the power receiving coil 91 and output the echo signal E1 to the identification unit 141.

The identification unit 141 acquires an X-coordinate of the power receiving coil 91 based on position information on each of the first search coils 310 and a voltage level of the echo signal E1. In one example, the identification unit 141 sets, as the X-coordinate of the power receiving coil 91, an X-coordinate of the first search coil 310 whose level of the echo signal E1 is equal to or higher that a threshold voltage and is the largest among the first search coils 310.

A central coordinate of the first search coil 310 in the X direction (left-right direction) may be set as the X-coordinate of the power receiving coil 91. If acquiring the X-coordinate of the power receiving coil 91 more accurately, interpolation may be executed based on magnitudes of the echo signals E1 of the first search coils 310 adjacent to each other to acquire the X-coordinate of the power receiving coil 91.

Incidentally, in a case that there is already the power receiving terminal 9 that is being charged, a detection voltage may increase and exceed a threshold voltage th due to a noise signal N1 generated by the power transfer, as illustrated in FIG. 7C. In such a case, there is a possibility that erroneous detection may occur such that a power receiving coil 91 of another power receiving terminal 9 is placed. Accordingly, in the first embodiment, in order not to use the first search coil 310 and the second search coil 320 each being in the above-described situation during position detection, these first search coil 310 and second search coil 320 are set as deactivated coils that are not used for position detection.

Next, the operation of the position detection device 3 will be described. In an initial state, it is assumed that the power receiving terminal 9 including the power receiving coil 91 as a position detection target is not placed, or only one power receiving terminal 9 including the power receiving coil 91 is placed.

Under control of the controller 14, the position detection device 3 outputs the position detection pulse signal P1 illustrated in FIG. 7A to the first search coil 310 at every predetermined terminal detection timing, and compares an output voltage of the first search coil 310 after output with the predetermined threshold voltage th.

After comparing the output voltage of the first search coil 310, the position detection device 3 outputs the position detection pulse signal P1 illustrated in FIG. 7A to the second search coil 320, and compares an output voltage of the second search coil 320 after output with the predetermined threshold voltage th.

When the power receiving terminal 9 is not placed on the upper surface of the position detection device 3, the echo signal E1 is not output from the power receiving coil 91 of the power receiving terminal 9. Therefore, the output voltages of the first search coils 310 and the second search coils 320 do not exceed the predetermined threshold voltage th.

Meanwhile, when the power receiving terminal 9 is placed on the upper surface of the position detection device 3, the echo signal E1 is output from the power receiving coil 91 of the power receiving terminal 9. The position detection device 3 specifies the first search coil 310 and the second search coil 320 whose output voltages exceed the predetermined threshold voltage th from among the first search coils 310 and the second search coils 320.

The position detection device 3 then determines the first search coil 310 and the second search coil 320 from which the higher output voltages are detected. The position detection device 3 acquires, as the position of the power receiving coil 91 of the power receiving terminal 9, a position where the determined first search coil 310 and the determined second search coil 320 intersect with each other in a plan view of the position detection device 3.

Instead of the above-described position where the determined first search coil 310 and the determined second search coil 320 intersect each other, the position of the power receiving coil 91 of the power receiving terminal 9 may be acquired by the following method.

Specifically, a graph is assumed, in which the detection voltages of the first search coils 310 whose output voltages exceed the predetermined threshold voltage th are arranged in an order of positions of the first search coils 310. Then, interpolation of the detection voltages is executed to calculate a first position that is the highest voltage position on the graph.

Similarly, a graph is assumed, in which the detection voltages of the second search coils 320 whose output voltages exceed the predetermined threshold voltage th are arranged in an order of positions of the second search coils 320. Then, interpolation of the detection voltages is executed to calculate a second position that is the highest voltage position on the graph. Thereafter, the position of the power receiving coil 91 of the power receiving terminal 9 is acquired by specifying an intersection between a straight line passing through the first position and extending in the first direction and a straight line passing through the second position and extending in the second direction.

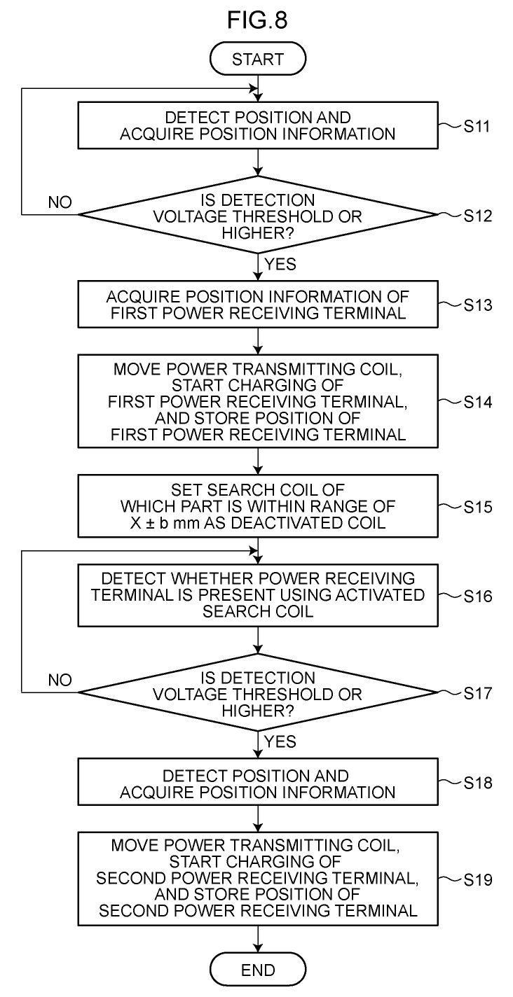

Next, the operation of the wireless power transfer device 1 according to the first embodiment will be described. FIG. 8 is a process flowchart illustrating an operation of the first embodiment. When a predetermined timing of detecting presence and absence of a power receiving terminal is reached, the wireless power transfer device 1 executes a process of detecting whether the power receiving terminal 9 is present by using the position detection device 3 (Step S11).

In the detection process of Step S11, the position detection device 3 determines whether a detection level of a voltage of any of the first search coils 310 and the second search coils 320 is the predetermined threshold voltage th or higher (Step S12).

In the determination of Step S12, when the detection levels of the voltages of all the first search coils 310 and the second search coils 320 are lower than the predetermined threshold voltage th (Step S12; No), the process proceeds to Step S11. The position detection device 3 enters a standby state until the next detection timing, and the above-described process is executed at the next detection timing.

In the determination of Step S12, when the detection level of the voltage of any of the first search coils 310 and the second search coils 320 is the predetermined threshold voltage th or higher (Step S12; Yes), the above-described position detection process is executed by the position detection device 3 to acquire position information of a first power receiving terminal 9 (Step S13).

Next, the controller 14 moves the power transmitting coil 81 to a position corresponding to the position information of the first power receiving terminal 9 by the moving system M1, starts power transfer (charging) to the first power receiving terminal 9, and stores the position information of the first power receiving terminal 9 in a memory (not illustrated) (Step S14).

In this state, since the power receiving terminal 9 to which power is being transferred (charged) is already present, influence on position detection of another power receiving terminal 9 needs to be avoided. Therefore, for avoiding influence of a magnetic flux (magnetic field) generated by power transfer on the position detection process of the position detection device 3, some of the first search coils 310 and some of the second search coils 320, which are not used for position detection, are set to be deactivated (Step S15).

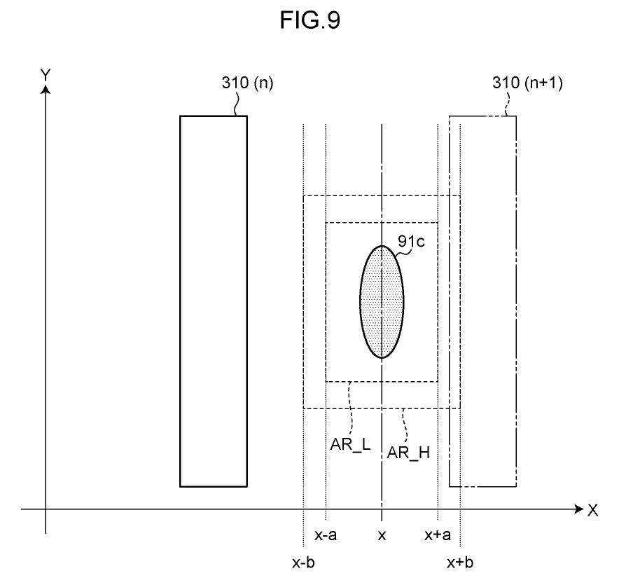

The settings of the first search coil 310 and the second search coil 320 that are not used for position detection will be described by using the first search coil 310 as an example. FIG. 9 is a diagram illustrating a setting of the first search coil that is not used for position detection and is deactivated. In the following description, a case of the transfer power being 5 W and a case of the transfer power being 12 W are exemplified. As illustrated in FIG. 9, when assuming that an X-coordinate of the power receiving coil 91 of the power receiving terminal 9 that is receiving power is x, a region where the first search coil 310 is affected when a power of 5 W is being transferred is part of the first search coil 310 included in an X-coordinate range AR_L = x + a to x − a.

Similarly, when assuming that an X-coordinate of the power receiving coil 91 of the power receiving terminal 9 that is receiving power is x, a region where the first search coil 310 is affected when a power of 12 W is being transferred is part of the first search coil 310 included in in an X-coordinate range AR_H = x + b to x − b (where, a < b).

More specifically, in the example illustrated in FIG. 9, the whole region of the first search coil 310(n) positioned in an n-th row is not included in any of the X-coordinate range AR_L = x + a to x − a and the X-coordinate range AR_H = x + b to x − b. Accordingly, in any case of 5 W power transfer and 12 W power transfer, the detection voltage of the first search coil 310(n) is not affected. Thus, the position detection device 3 recognizes the first search coil 310(n) as a search coil that is available for position detection. Meanwhile, the whole region of the first search coil 310(n+1) positioned in an (n+1)-th row is not included in the X-coordinate range AR_L = x + a to x − a, whereas part of the first search coil 310(n+1) is included in the X-coordinate range AR_H = x + b to x − b. Accordingly, the detection voltage of the first search coil 310(n) is not affected in 5 W power transfer, but is affected in 12 W power transfer. In the position detection device 3, there is a possibility that erroneous detection occurs unless the transfer power level (5 W or 12 W) is determined in advance. Therefore, the first search coil 310(n+1) is set as a search coil that is deactivated for position detection.

In the first embodiment, the transmission power level (in the above-described example, in any case of 5 W power transfer or 12 W power transfer) is not determined. Therefore, to more reliably prevent erroneous detection, a deactivated search coil is set by using the X-coordinate range = x + b to x – b, which corresponds to the region in which the first search coil 310 is affected when 12 W power is being transferred.

As described above, when at least part of the first search coil 310 is included in the region affected by power transfer, the detection voltage may increase and exceed the threshold voltage th even if the echo signal E1 is not present in the first search coil 310 as illustrated in FIG. 7C due to the noise signal N1 generated by power transfer to the power receiving terminal 9 that is already being executed. As a result, there is a high possibility that the position of the power receiving coil 91 is erroneously detected.

Accordingly, since the positions of the first search coils 310 are stored in advance, the position detection device 3 can cause the first search coil 310 not to be used for position detection when it is included in a predetermined X-coordinate range.

Note that, not being used for position detection may mean any of the following two aspects. According to the first aspect, the position detection device 3 outputs the position detection pulse signal P1 to the first search coil 310 that is set to not be used for position detection, but does not detect the echo signal E1. As a result, regardless of whether the echo signal E1 is generated and the detection voltage of the first search coil 310, whether the detection voltage of the first search coil 310 is the threshold voltage th or higher is not determined, and thus, the first search coil 310 is not used for position detection.

According to the second aspect, the position detection device 3 does not output the position detection pulse signal P1 to the first search coil 310 that is set to not be used for position detection, and also does not detect the echo signal E1. As a result, the echo signal E1 is also not generated, and regardless of the detection voltage of the first search coil 310, whether the detection voltage of the first search coil 310 is the threshold voltage th or higher is not determined, and thus, the first search coil 310 is not used for position detection.

Also for the second search coils 320, when assuming that an Y-coordinate of the power receiving coil 91 of the power receiving terminal 9 that is receiving power is y, a region where the second search coil 320 is affected when a power of 5 W is being transferred is part of the second search coil 320 included in a Y-coordinate range of y + a to y – a.

When assuming that an Y-coordinate of the power receiving coil 91 of the power receiving terminal 9 that is receiving power is y, a region where the second search coil 320 is affected when a power of 12 W is being transferred is part of the second search coil 320 included in a Y-coordinate range of y + b to y − b (where, a < b).

In the first embodiment, as described above, the transmission power (in the above-described example, in any case of 5 W power transfer or 12 W power transfer) is not determined. Therefore, to more reliably prevent erroneous detection, a deactivated search coil is set by using the Y-coordinate range = y + b to y – b, which corresponds the region in which the second search coil 320 is affected when a power of 12 W is being transferred.

When the setting of the first search coil 310 and the second search coil 320 that are not used for position detection is completed, the position detection device 3 restricts the available first search coil 310 and second search coil 320 that are used for position detection by excluding the deactivated first search coil 310 and second search coil 320 that are not used for position detection, and then executes a process of detecting whether a new power receiving terminal 9 is present (Step S16).

In the detection process of Step S11, the position detection device 3 determines whether the detection level of the voltage of any of the first search coils 310 and the second search coils 320 is the predetermined threshold voltage th or higher (Step S17).

In the determination of Step S17, when the detection levels of the voltages of all the first search coils 310 and the second search coils 320 are lower than the predetermined threshold voltage th (Step S17; No), the process proceeds to Step S16. The position detection device 3 enters a standby state until the next detection timing, and executes the above-described process at the next detection timing.

In the determination of Step S17, when the detection level of the voltage of any of the first search coils 310 and the second search coils 320 is the predetermined threshold voltage th or higher (Step S17; Yes), the above-described position detection process is executed by the position detection device 3 to acquire position information of a second power receiving terminal 9 (Step S18).

Subsequently, the controller 14 moves, by the moving system M1, the power transmitting coil 81 that is not currently performing the charging to a position corresponding to the position information of the second power receiving terminal 9, starts power transfer (charging) to the second power receiving terminal 9, and stores the position information of the second power receiving terminal 9 in a memory (not illustrated) (Step S19).

As described above, in the first embodiment, even when a power-transferred device to which power is already being transferred is present, influence of power transfer on the position detection device 3 can be reduced, and the position of the new power-transferred device can be correctly detected.

### Second Embodiment

A second embodiment is different from the above-described first embodiment in that, the maximum transmission power corresponding to a transmission power mode for the power receiving terminal 9 is acquired and a search coil that is not used for position detection is set based on the maximum transmission power. A device configuration of the second embodiment is the same as the first embodiment, and an operation of the wireless power transfer device 1 according to the second embodiment will be described below.

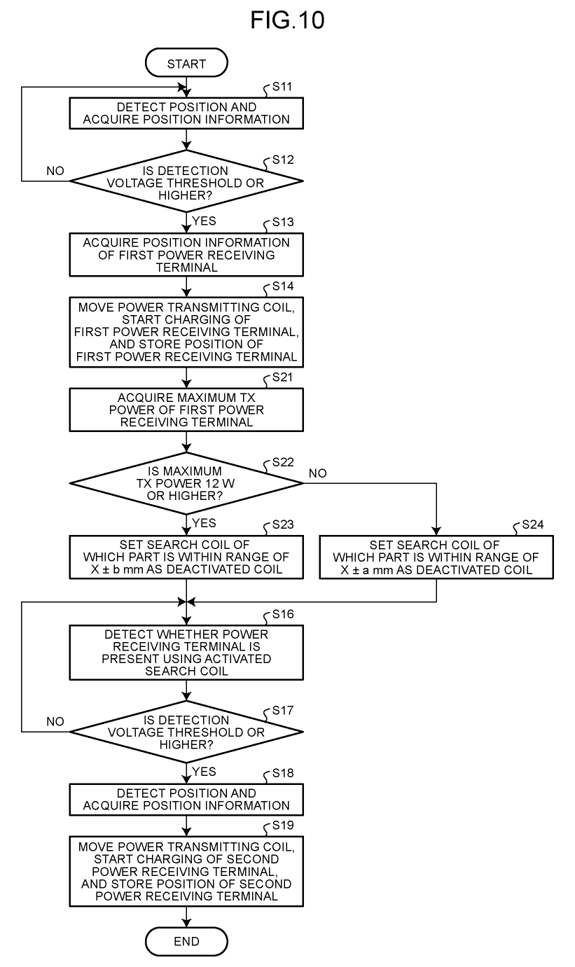

FIG. 10 is a process flowchart illustrating an operation of the second embodiment. In FIG. 10, the same parts as those of FIG. 8 are represented by the same reference signs. When a predetermined timing of detecting presence and absence of a power receiving terminal is reached, the wireless power transfer device 1 executes a process of detecting whether the power receiving terminal 9 is present using the position detection device 3 (Step S11).

In the detection process of Step S11, the position detection device 3 determines whether a detection level of a voltage of any of the first search coils 310 and the second search coils 320 is the predetermined threshold voltage th or higher (Step S12).

In the determination of Step S12, when the detection levels of the voltages of all the first search coils 310 and the second search coils 320 are lower than the predetermined threshold voltage th (Step S12; No), the process proceeds to Step S11. The position detection device 3 enters a standby state until the next detection timing, and the above-described process is executed at the next detection timing.

In the determination of Step S12, when the detection level of the voltage of any of the first search coils 310 and the second search coils 320 is the predetermined threshold voltage th or higher (Step S12; Yes), the above-described position detection process is executed by the position detection device 3 to acquire position information of a first power receiving terminal 9 (Step S13).

Next, the controller 14 moves the power transmitting coil 81 to a position corresponding to the position information of the first power receiving terminal 9 by the moving system M1, starts power transfer (charging) to the first power receiving terminal 9, and stores the position information of the first power receiving terminal 9 in a memory (not illustrated) (Step S14).

The position detection device 3 acquires, from the controller 14, the maximum transmission (TX) power corresponding to the transmission power mode for the first power receiving terminal 9 (Step S21). The position detection device 3 determines whether the maximum transmission (TX) power corresponding to the transmission power mode for the first power receiving terminal 9 is 12 W or higher (Step S22).

In the determination of Step S22, when the maximum transmission power corresponding to the transmission power mode for the first power receiving terminal 9 is 12 W or higher (Step S22; Yes), the power receiving terminal 9 to which power is already being transferred (charged) is present, and thus the position detection device 3 needs to avoid influence on position detection of another power receiving terminal 9.

Therefore, the position detection device 3 sets the first search coil 310 and the second search coil 320 that are not used for position detection when the maximum transmission power is 12 W or higher (Step S23).

More specifically, when assuming that an X-coordinate of the power receiving coil 91 of the power receiving terminal 9 that is receiving power is x, a region where the first search coil 310 is affected when a power of 12 W is being transferred is the first search coil 310 that is partly included in the X-coordinate range of x + b to x − b (where, a < b). Accordingly, such a first search coil 310 is set as the first search coil 310 that is not used for position detection and is deactivated.

Similarly, when assuming that a Y-coordinate of the power receiving coil 91 of the power receiving terminal 9 that is receiving power is y, a region where the second search coil 320 is affected when a power of 12 W is being transferred is the second search coil 320 that is partly included in the Y-coordinate range of y + b to y − b (where, a < b) . Accordingly, such a second search coil 320 is set as the second search coil 320 that is not used for position detection and is deactivated.

In the determination of Step S22, when the maximum transmission power corresponding to the transmission power mode for the first power receiving terminal 9 is lower than 12 W (Step S22; No), the power receiving terminal 9 to which power is already being transferred (charged) is present, and thus the position detection device 3 needs to avoid influence on position detection of another power receiving terminal 9.

Therefore, when the maximum transmission power is lower than 12 W (for example, 5 W), the position detection device 3 sets the first search coil 310 and the second search coil 320 that are not used for position detection (Step S24).

More specifically, when assuming that an X-coordinate of the power receiving coil 91 of the power receiving terminal 9 that is receiving power is x, a region where the first search coil 310 is affected when a power of 5 W is being transferred is the first search coil 310 that is partly included in in the X-coordinate range of x + a to x − a (where, a < b), as illustrated in FIG. 9. Accordingly, such a first search coil 310 is set as the first search coil 310 that is not used for position detection and is deactivated.

Similarly, when assuming that a Y-coordinate of the power receiving coil 91 of the power receiving terminal 9 that is receiving power is y, a region where the second search coil 320 is affected when a power of 5 W is being transferred is the second search coil 320 that is partly included in the Y-coordinate range of y + a to y − a (where, a < b) . Accordingly, such a second search coil 320 corresponding to the region is set as the second search coil 320 that is not used for position detection and is deactivated.

When the setting of the first search coil 310 and the second search coil 320 that are not used for position detection is completed, the position detection device 3 restricts the available first search coil 310 and second search coil 320 that are used for position detection by excluding the deactivated first search coil 310 and second search coil 320 that are not used for position detection, and then executes a process of detecting whether a new power receiving terminal 9 is present (Step S16).

In the detection process of Step S11, the position detection device 3 determines whether the detection level of the voltage of any of the first search coils 310 and the second search coils 320 is the predetermined threshold voltage th or higher (Step S17).

In the determination of Step S17, when the detection levels of the voltages of all the first search coils 310 and the second search coils 320 are lower than the predetermined threshold voltage th (Step S17; No), the process proceeds to Step S16. The position detection device 3 enters a standby state until the next detection timing, and executes the above-described process at the next detection timing.

In the determination of Step S17, when the detection level of the voltage of any of the first search coils 310 and the second search coils 320 is the predetermined threshold voltage th or higher (Step S17; Yes), the above-described position detection process is executed by the position detection device 3 to acquire position information of a second power receiving terminal 9 (Step S18).

Subsequently, the controller 14 moves, by the moving system M1, the power transmitting coil 81 that is not currently performing the charging to a position corresponding to the position information of the second power receiving terminal 9, starts power transfer (charging) to the second power receiving terminal 9, and stores the position information of the second power receiving terminal 9 in a memory (not illustrated) (Step S19).

As described above, in the second embodiment, even when a power-transferred device to which power is already being transferred is present, the number of the first search coils 310 and the second search coils 320 that are not used for position detection is minimized based on the maximum transmission power. With this configuration, influence of power transfer on the position detection device 3 can be reduced and more positions at which the position of the new power-transferred device can be correctly detected can be ensured. Alternatively, by increasing the number of the power transmitting coils, power can be transferred to a larger number of power receiving terminals with the same area.

### Third Embodiment

A third embodiment is different from the first embodiment and the second embodiment described above in that, the threshold voltage used for position detection is changed and set without being constant. A device configuration of the third embodiment is the same as the first embodiment, and an operation of the wireless power transfer device 1 according to the third embodiment will be described below.

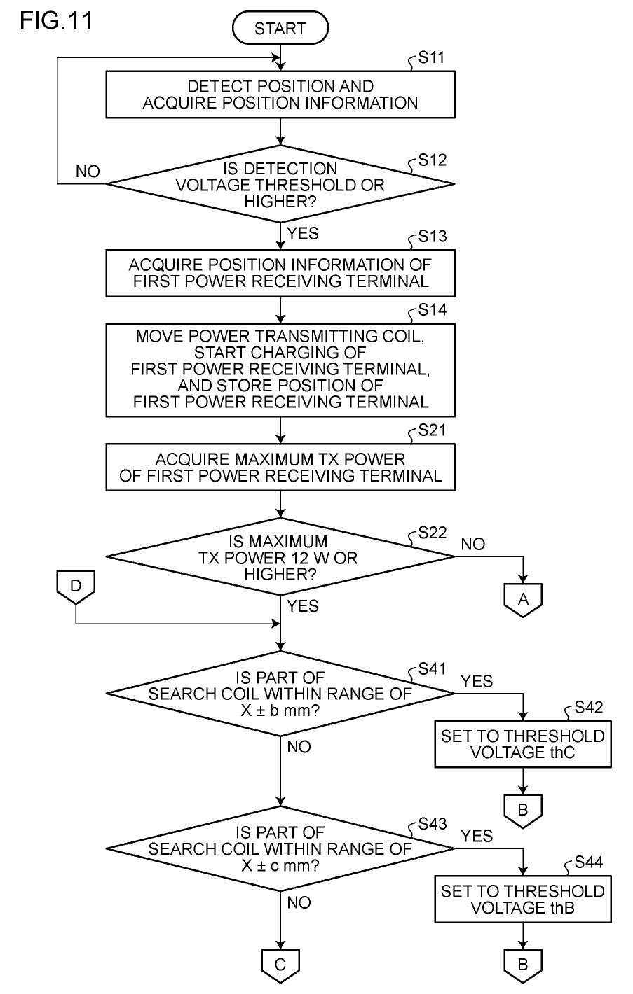

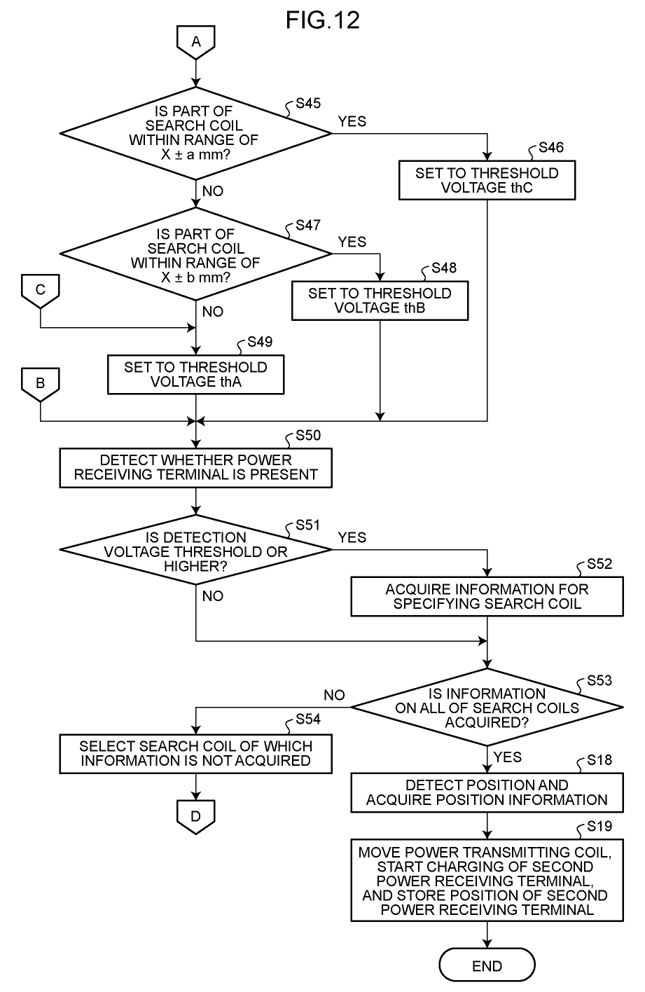

FIG. 11 is a process flowchart (1) illustrating an operation of the third embodiment. FIG. 12 is a process flowchart (2) illustrating the operation of the third embodiment. In FIGS. 11 and 12, the same parts as those of the second embodiment of FIG. 10 are represented by the same reference signs. In the following description, for easy understanding, a process for the first search coils 310 will be mainly described. Note that the same process is executed on the second search coil 320. When a predetermined timing of detecting presence and absence of a power receiving terminal is reached, the wireless power transfer device 1 executes a process of detecting whether the power receiving terminal 9 is present using the position detection device 3 (Step S11).

In the detection process of Step S11, the position detection device 3 determines whether a detection level of a voltage of any of the first search coils 310 and the second search coils 320 is the predetermined threshold voltage th or higher (Step S12).

In the determination of Step S12, when the detection levels of the voltages of all the first search coils 310 and the second search coils 320 are lower than the predetermined threshold voltage th (Step S12; No), the process proceeds to Step S11. The position detection device 3 enters a standby state until the next detection timing, and the above-described process is executed at the next detection timing.

In the determination of Step S12, when the detection level of the voltage of any of the first search coils 310 and the second search coils 320 is the predetermined threshold voltage th or higher (Step S12; Yes), the above-described position detection process is executed by the position detection device 3 to acquire position information of a first power receiving terminal 9 (Step S13).

Next, the controller 14 moves the power transmitting coil 81 to a position corresponding to the position information of the first power receiving terminal 9 by the moving system M1, starts power transfer (charging) to the first power receiving terminal 9, and stores the position information of the first power receiving terminal 9 in a memory (not illustrated) (Step S14). The position detection device 3 acquires, from the controller 14, the maximum transmission (TX) power corresponding to the transmission power mode for the first power receiving terminal 9 (Step S21). The position detection device 3 determines whether the maximum transmission (TX) power corresponding to the transmission power mode for the first power receiving terminal 9 is 12 W or higher (Step S22). In the following description, for easy understanding, the first search coil 310 will be mainly described as an example.

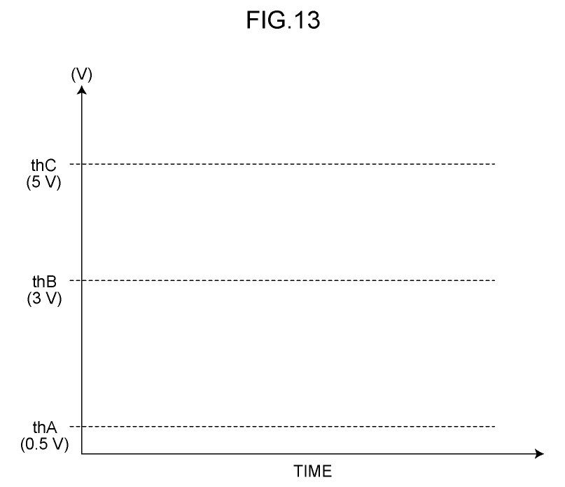

FIG. 13 is a diagram illustrating a threshold voltage setting example. In the following description, it is assumed that three threshold voltages thA, thB, and thC are used as threshold voltages corresponding to detection voltages.

The threshold voltage thA is set on the assumption that influence of power transfer on another power receiving terminal 9 has a minimum influence on position detection of a new power receiving terminal. In the example of FIG. 13, the threshold voltage thA is 0.5 V.

The threshold voltage thB is set on the assumption that influence of power transfer on another power receiving terminal 9 has a slightly large influence on position detection of a new power receiving terminal. In the example of FIG. 13, the threshold voltage thB is 3 V.

For example, the threshold voltage thC is a threshold voltage that is set on the assumption that influence of power transfer on another power receiving terminal 9 has a large influence on position detection of a new power receiving terminal. In the example of FIG. 13, the threshold voltage thC is 5 V.

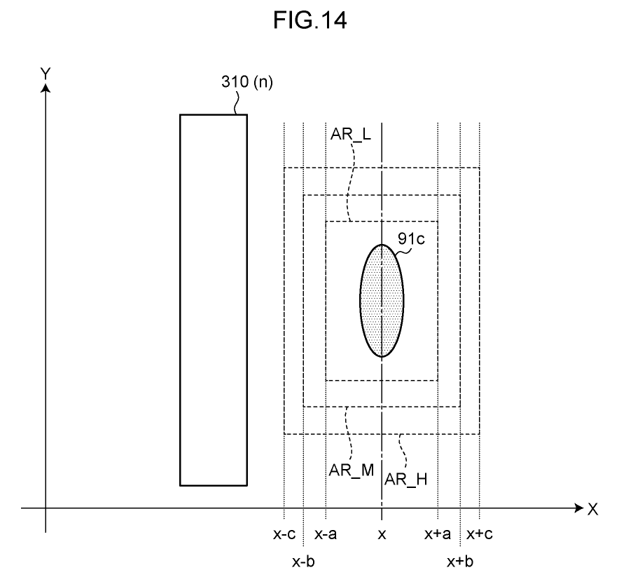

FIG. 14 is a diagram illustrating an X-coordinate range. It is assumed that an X-coordinate of a power receiving coil 91c of the power receiving terminal 9 that is receiving power is x. In the determination of Step S22, when the maximum transmission power corresponding to the transmission power mode for the first power receiving terminal 9 is 12 W or higher (Step S22; Yes), the position detection device 3 determines whether the first search coil 310 (in the example of FIG. 14, the first search coil 310(n)) is partly included in an X-coordinate range AR_M = x + b to x − b (where, a < b) (Step S41).

In the determination of Step S41, when at least part of the first search coil 310 is included in the X-coordinate range AR_M = x + b to x − b (Step S41; Yes), the position detection device 3 sets the threshold voltage for detecting presence/absence as the threshold voltage thC (in the above-described example, 5 V) that is least affected by power transfer to the power receiving terminal 9 among the predetermined threshold voltages (Step S42), and the process proceeds to Step S50.

In the determination of Step S41, when the first search coil 310 is not included in the X-coordinate range AR_M = x + b to x − b (Step S41; No), the position detection device 3 determines whether at least part of the first search coil 310 is included in an X-coordinate range AR_H = x + c to x − c (where, b < c) (Step S43).

In the determination of Step S43, when at least part of the first search coil 310 is included in the X-coordinate range AR_H = x + c to x − c (Step S43; Yes), the position detection device 3 sets the threshold voltage for detecting presence/absence as the threshold voltage thB (in the above-described example, 3 V) that is easily affected by power transfer to the power receiving terminal 9 than the threshold voltage thC (for example, 5 V) that is least affected by power transfer to the power receiving terminal 9 among the predetermined threshold voltages thA, thB, and thC (Step S44), and the process proceeds to Step S50.

In the determination of Step S43, when the first search coil 310 is not included in the X-coordinate range AR_H = x + c to x − cb (Step S43; No), the position detection device 3 sets the threshold voltage for detecting presence/absence as the threshold voltage thA (in the above-described example, 0.5 V) that is most affected by power transfer to the power receiving terminal 9 among the predetermined threshold voltages thA, thB, and thC (Step S49), and the process proceeds to Step S50.

Meanwhile, in the determination of Step S22, when the maximum transmission power corresponding to the transmission power mode for the first power receiving terminal 9 is lower than 12 W (Step S22; No), the position detection device 3 determines whether at least part of the first search coil 310 is included in the X-coordinate range of x + a to x − a (where, a < b < c) (Step S45).

In the determination of Step S45, when at least part of the first search coil 310 is positioned in the X-coordinate range AR_L = x + a to x − a (Step S45; Yes), the position detection device 3 sets the threshold voltage for detecting presence/absence as the threshold voltage thC (in the above-described example, 5 V) that is least affected by power transfer to the first search coil 310 among the predetermined threshold voltages thA, thB, and thC (Step S46), and the process proceeds to Step S50.

In the determination of Step S45, when the first search coil 310 is not included in the X-coordinate range AR_L = x + a to x − a (Step S45; No), the position detection device 3 determines whether at least part of the first search coil 310 is included in the X-coordinate range = x + b to x − b (where, a < b < c) (Step S47).

In the determination of Step S47, when at least part of the first search coil 310 is positioned in the X-coordinate range AR_L = x + a to x − a (Step S47; Yes), the position detection device 3 sets the threshold voltage for detecting presence/absence as the threshold voltage thB (in the above-described example, 3 V) that is easily affected by power transfer to the power receiving terminal 9 than the threshold voltage thC (for example, 5 V) that is least affected by power transfer to the power receiving terminal 9 among the predetermined threshold voltages thA, thB, and thC (Step S48), and the process proceeds to Step S50.

In the determination of Step S47, when the first search coil 310 is not positioned in the X-coordinate range AR_L = x + a to x − a (Step S47; No), the position detection device 3 sets the threshold voltage for detecting presence/absence as the threshold voltage thA (in the above-described example, 0.5 V) that is most affected by power transfer to the power receiving terminal 9 among the predetermined threshold voltages thA, thB, and thC (Step S49), and detects whether the receiving terminal is present (Step S50).

Subsequently, the position detection device 3 determines whether the detection level of the voltage of the first search coil 310 is the predetermined set threshold voltage (threshold voltage thA) or higher (Step S51).

In the determination of Step S51, when the detection level of the voltage of the first search coil 310 is the predetermined set threshold voltage thA or higher (Step S51; Yes), the position detection device 3 acquires position information and detection voltage information of the search coil of which the detection voltage exceeds the set threshold voltage thA, as information for specifying the first search coil 310 (Step S52), and the process proceeds to Step S53.

In the determination of Step S51, when the detection level of the voltage of the first search coil 310 is lower than the predetermined set threshold voltage thA (Step S51; No), the position detection device 3 determines whether acquisition of information on all the search coils is completed (Step S53).

In the determination of Step S53, when acquisition of information on all the search coils is not completed (Step S53; No), the position detection device 3 selects a search coil of which information is not yet acquired (Step S54). Then, the process proceeds to Step S41 again, and the above-described processes are repeated.

In the determination of Step S53, when acquisition of information on all the search coils is completed (Step S53; Yes), the position detection device 3 executes the above-described position detection process based on the acquired information on the search coils (the position information and the detection voltage information of the search coils of which the detection voltages exceed the set threshold voltage), and acquires the position information of the second power receiving terminal 9 (Step S18).

Next, the controller 14 moves the power transmitting coil 81 that is not currently used for charging to a position corresponding to the position information of the second power receiving terminal 9 by the moving system M1, starts power transfer (charging) to the second power receiving terminal 9, and stores the position information of the second power receiving terminal 9 in a memory (not illustrated) (Step S19).

As described above, in the third embodiment, even when a power-transferred device to which power is already being transferred is present, a suitable threshold voltage (any of the threshold voltages thA, thB, and thC) is used for each of all the first search coils 310 and the second search coils 320. With this configuration, influence of power transfer on the position detection device 3 can be reduced and more positions at which the position of the new power-transferred device can be correctly detected can be ensured. Alternatively, by increasing the number of the power transmitting coils, power can be transferred to a larger number of power receiving terminals with the same area.

### Fourth Embodiment

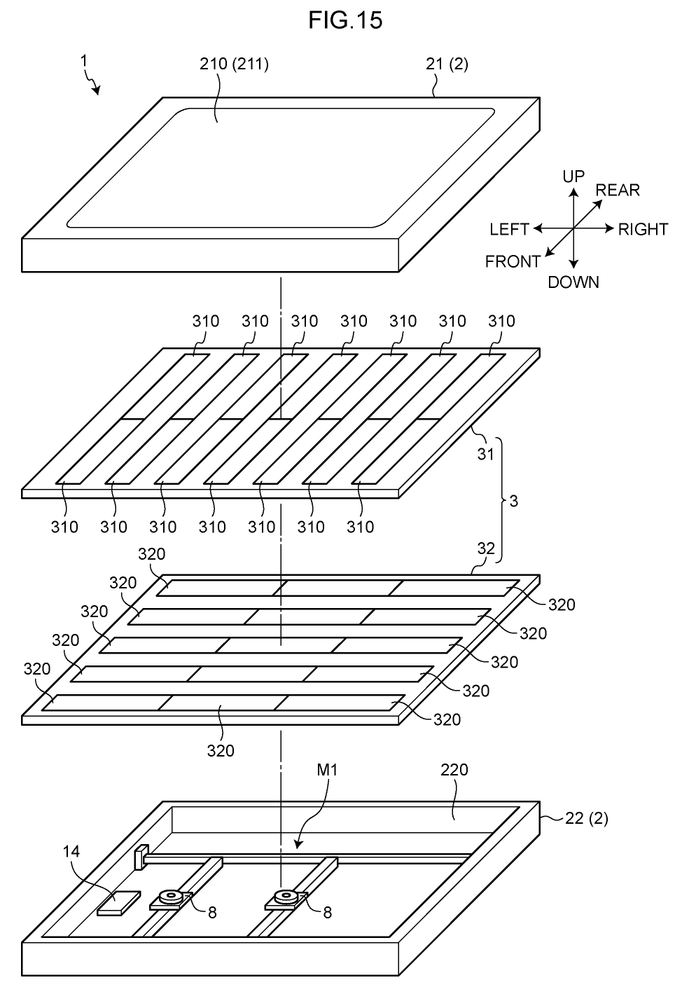

In each of the above-described embodiments, the plurality of first search coils 310 arranged in rows in a first direction, and the plurality of second search coils 320 arranged in rows in a second direction intersecting the first direction are provided. In a fourth embodiment, in at least either one of the first search coils 310 or the second search coils 320, two or more search coils are arranged in the same row. FIG. 15 is a diagram illustrating a specific example of the fourth embodiment. In FIG. 15, the first search coils 310 arranged in rows in the first direction are provided such that two first search coils 310 are disposed in the same row. The second search coils 320 arranged in rows in the second direction intersecting the first direction are provided such that three second search coils 320 are disposed in the same row. When the fourth embodiment is applied to the first embodiment and the second embodiment, the search coils that are set as deactivated coils can be reduced, and position detection can be more reliably executed. Moreover, when the fourth embodiment is applied to any of the first to third embodiments, position detection can be executed with higher accuracy.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless power transfer device comprising:
a plurality of power transmitting coils;
a plurality of first search coils arranged in rows in a first direction;
a plurality of second search coils arranged in rows in a second direction intersecting the first direction;
a position detection device configured to
output a position detection pulse signal to the first search coils and the second search coils,
receive an echo signal from a power-transferred device via the first search coils and the second search coils, and
detect a position of a power receiving coil of the power-transferred device placed on a predetermined charging surface based on detection voltages of the echo signal in the first search coils and the second search coils;
a moving system configured to move one of the power transmitting coils to a position facing the position of the power receiving coil detected by the position detection device; and
a plurality of power transmission circuits configured to supply power for transfer to the power transmitting coils,
wherein the position detection device is configured to set, as deactivated coils, the first search coil and the second search coil that are positioned within a range of a predetermined distance from the position of the power receiving coil of the power-transferred device when power is being transferred via any of the power transmitting coils to the power receiving coil.

2. The wireless power transfer device according to claim 1, wherein the predetermined distance is set to be longer as the transmission power is larger based on transmission power from the power transmitting coil.

3. The wireless power transfer device according to claim 1, wherein the position detection device is configured to compare the detection voltage in the first search coil and the second search coil with a predetermined threshold voltage to perform the detection of the position of the power receiving coil of the power-transferred device.

4. The wireless power transfer device according to claim 3, wherein the threshold voltage is set to be higher as the transmission power is larger based on transmission power from the power transmitting coil.

5. The wireless power transfer device according to claim 3, wherein
a plurality of the threshold voltages are provided, and
the threshold voltages are set to be higher as the transmission power is larger based on transmission power from the power transmitting coil.

6. The wireless power transfer device according to claim 1, wherein the first search coils are arranged such that two or more of the first search coils are disposed in each row in the first direction.

7. The wireless power transfer device according to claim 1, wherein the second search coils are arranged such that two or more of the second search coils are disposed in each row in the second direction.

8. The wireless power transfer device according to claim 1, wherein the position detection device is configured, when setting the first search coil or the second search coil as the deactivated coil, to stop output of the position detection pulse signal to the first search coil or the second search coil to be set as the deactivated coil.

9. The wireless power transfer device according to claim 1, wherein the position detection device is configured, when setting the first search coil or the second search coil as the deactivated coil, perform no detection of an echo signal from the power transfer device via the first search coil or the second search coil to be set as the deactivated coil.

10. A wireless power transfer device comprising:
a plurality of power transmitting coils;
a plurality of first search coils arranged in rows in a first direction;
a plurality of second search coils arranged in rows in a second direction intersecting the first direction;
a position detection device configured to
output a position detection pulse signal to the first search coils and the second search coils,
receive an echo signal from a power-transferred device via the first search coils and the second search coils, and
detect a position of a power receiving coil of the power-transferred device placed on a predetermined charging surface based on detection voltages of the echo signal in the first search coils and the second search coils;
a moving system configured to move one of the power transmitting coils to a position facing the position of the power receiving coil detected by the position detection device; and
a plurality of power transmission circuits configured to supply power for transfer to the power transmitting coils,
wherein, in at least either one of the first search coils or the second search coils, a plurality of search coils are disposed in the same row, and
wherein the position detection device is configured to set, as deactivated coils, the first search coil and the second search coil that are positioned within a range of a predetermined distance from the position of the power receiving coil of the power-transferred device when power is being transferred via any of the power transmitting coils to the power receiving coil.

11. The wireless power transfer device according to claim 10, wherein the predetermined distance is set to be longer as the transmission power is larger based on transmission power from the power transmitting coil.

12. The wireless power transfer device according to claim 10, wherein the position detection device is configured to compare the detection voltage in the first search coil and the second search coil with a predetermined threshold voltage to perform the detection of the position of the power receiving coil of the power-transferred device.

13. The wireless power transfer device according to claim 12, wherein the threshold voltage is set to be higher as the transmission power is larger based on transmission power from the power transmitting coil.

14. The wireless power transfer device according to claim 12, wherein
a plurality of the threshold voltages are provided, and
the threshold voltages are set to be higher as the transmission power is larger based on transmission power from the power transmitting coil.
